(19) United States
(12) Patent Application Publication
(10) Pub. No.: US 2026/0129713 A1
(43) Pub. Date: May 7, 2026

(54) METHOD AND APPARATUS OF SUPPORTING ARTIFICIAL INTELLIGENCE AND MACHINE LEARNING FUNCTIONALITY

(71) Applicant: WNC Corporation, Hsinchu (TW)

(72) Inventor: Hung-Chen CHEN, Hsinchu (TW)

(21) Appl. No.: 19/380,153

(22) Filed: Nov. 5, 2025

Related U.S. Application Data
(60) Provisional application No. 63/717,395, filed on Nov. 7, 2024.

(51) Int. Cl. H04W 76/27; H04W 24/10

(52) U.S. Cl. CPC H04W 76/27; H04W 24/10

(57) ABSTRACT

A method of supporting artificial intelligence and machine learning functionality is provided. The method includes receiving an RRC reconfiguration message including an inference configuration associated with a UE-side functionality. The method includes determining an applicability status of the inference configuration of the UE-side functionality. The method includes transmitting a first RRC reconfiguration complete message including the applicability status of the inference configuration of the UE-side functionality. In a case that a report configuration of applicability included in the RRC reconfiguration message is enabled, and a current applicability status of the inference configuration of the UE-side functionality is different from a previous applicability status reported in an RRC message, transmitting the current applicability status of the configuration of the UE-side functionality in a second UE assistance information message.

### CROSS REFERENCE TO RELATED APPLICATIONS

This application claims the benefit of U.S. Provisional Application No. 63/717,395, entitled “Method and Apparatus of Supporting Artificial Intelligence and Machine Learning in Radio Access Network”, filed on Nov. 7, 2024, the entirety of which is incorporated by reference herein.

### TECHNICAL FIELD

The present disclosure generally relates to wireless communication. More specifically, aspects of the present disclosure relate to a method and an apparatus of supporting artificial intelligence (AI) and machine learning (ML) functionality.

### BACKGROUND

Unless otherwise indicated herein, the approaches described in this section are not prior art to the claims listed below and are not admitted as prior art by inclusion in this section.

Nowadays, Artificial Intelligence/Machine Learning (AI/ML) techniques and relevant applications are being increasingly adopted by a wide variety of industries and have proved to be successful. One can foresee the potential benefits of AI/ML in a radio access network (RAN). For example, the AI/ML techniques can be adopted to boost the performance of the radio interface, reduce power consumption, or further improve user experience. However, the applications of AI/ML to wireless communications have been thus far limited to implementation-based approaches at the network or the UE sides, without any support from the 3GPP (the 3rd Generation Partnership Project) specifications. This results in a variety of implementations and UE behaviors from different vendors. Standardizing support for adopting AI/ML techniques can prove beneficial from a performance perspective because both the network and the UE sides can have consistent behavior for Life Cycle Management (LCM) operations. Specifically, LCM of AI/ML model (e.g., model training, model deployment, model inference, model monitoring, model updating) and AI/ML functionality can be controllable, and inference accuracy can be increased accordingly.

The adoption of AI/ML technology in an RAN is opening a new era for creating more business value in terms of improved system performance, higher efficiency, and better user experience. It will create new business models and use cases for 5G and future generation mobile networks. Although it has been proven that the air interface can be improved by the support of AI/ML, the overall design of adopting AI/ML techniques in RAN for the air interface is still under discussion.

In 3GPP Release 19, the target is to provide normative support for the general framework for AI/ML for air interface and to enable the recommended use cases in the preceding study (e.g., in 3GPP TR 38.843 v18), including beam management, positioning accuracy enhancements, and CSI (Channel Status Information) feedback enhancement.

BM (Beam Management) is an example. The objective is to perform DL (Downlink) Tx beam prediction for a UE-side model and for a network (NW)-side model. A UE-side (AI/ML) model is an AI/ML Model whose inference is performed entirely at the UE. Conversely, an NW-side (AI/ML) model is an AI/ML Model whose inference is performed entirely at the network. As introduced in 3 GPP Rel-18 TR 38.843, FIG. 1 shows an example of the inference procedure for beam management for BM-Case1 and BM-Case2. Measurements based on Set B of beams are used as model input. In addition, beam ID information may also be provided as input to the AI/ML model.

BM-Case1 is to perform Spatial-domain DL Tx beam prediction for Set A of beams based on measurement results of Set B of beams. That is, in the evaluation, the measurements of Set B are used as model input to predict Top-1/N beams from Set A. BM-Case2 is to perform temporal DL Tx beam prediction for Set A of beams based on the historic measurement results of Set B of beams. That is, in the evaluation, the measurements from historic time instances of Set B are used as model input for temporal DL beam prediction of beams from Set A.

Based on model output (e.g., probability of each beam in Set A to be the Top-1 beam, predicted L1-RSRPs), Top-1/N beam(s) among Set A of beams can be predicted and/or potentially with predicted L1-RSRPs. RSRP stands for Reference Signal Receiving Power.

Therefore, as stated in RP-242399, specification support of an AI/ML general framework for one-side AI/ML models (i.e., UE-side model or NW-side model) is required. The detailed designs for LCM to facilitate model training, inference, performance monitoring, and/or data collection for both UE-side and NW-side models are still under discussion. Therefore, there is a need to provide proper schemes to address this issue.

### SUMMARY

The following summary is illustrative only and is not intended to be limiting in any way. That is, the following summary is provided to introduce concepts, highlights, benefits, and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and an apparatus of supporting artificial intelligence (AI) and machine learning (ML) functionality are provided in the present disclosure. The main purpose of the disclosure is to complete the detailed mechanisms for LCM to facilitate model training, inference, performance monitoring, data collection, and also to provide the overall signaling procedure of applicable functionalities/models to support AI/ML for the air interface in RAN.

In an exemplary embodiment, a method of supporting artificial intelligence and machine learning functionality is provided. The method is implemented by a user equipment (UE) and includes receiving, from a base station, a Radio Resource Control (RRC) reconfiguration message including an inference configuration associated with a UE-side functionality. The method includes determining an applicability status of the inference configuration of the UE-side functionality. The method includes transmitting, to the base station, a first RRC reconfiguration complete message including the applicability status of the inference configuration of the UE-side functionality. In a case that a report configuration of applicability included in the RRC reconfiguration message is enabled, and a current applicability status of the inference configuration of the UE-side functionality is different from a previous applicability status reported in an RRC message, transmitting, to the base station, the current applicability status of the configuration of the UE-side functionality in a second UE assistance information message.

In an exemplary embodiment, an apparatus of supporting artificial intelligence and machine learning functionality is provided. The apparatus comprises a transceiver and a processor. The transceiver, which, during operation, wirelessly communicates with at least one network node. The processor is communicatively coupled to the transceiver such that, during operation, the processor performs operations comprising receiving, from a base station, a Radio Resource Control (RRC) reconfiguration message including an inference configuration associated with a UE-side functionality. The processor determines an applicability status of the inference configuration of the UE-side functionality. The processor transmits, to the base station, a first RRC reconfiguration complete message including the applicability status of the inference configuration of the UE-side functionality. In a case that a report configuration of applicability included in the RRC reconfiguration message is enabled, and a current applicability status of the configuration of the UE-side functionality is different from a previous applicability status reported in an RRC message, the processor transmits, to the base station, the current applicability status of the configuration of the UE-side functionality in a second UE assistance information message.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale, as some components may be shown out of proportion to their size in actual implementation in order to clearly illustrate the concept of the present disclosure.

FIG. 1 shows an example of the inference procedure for beam management for BM-Case1 and BM-Case2.

FIG. 2 shows a signaling procedure for supporting AI/ML general framework for UE-side AI/ML model according to an implementation of the present disclosure.

FIG. 3 shows a signaling procedure of supporting AI/ML general framework for NW-side AI/ML model according to an implementation of the present disclosure.

FIG. 4 shows an alternative signaling procedure of supporting AI/ML general framework for UE-side AI/ML model according to an implementation of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network functions or algorithms described in the present disclosure may be implemented by hardware, software or a combination of software and hardware. Described functions may correspond to modules which may be software, hardware, firmware, or any combination thereof. The software implementation may comprise computer executable instructions stored on computer-readable medium, such as memory or other type of storage devices. For example, one or more microprocessors or general-purpose computers with communication processing capability may be programmed with corresponding executable instructions and carry out the described network functions or algorithms. The microprocessors or general-purpose computers may be formed of Applications Specific Integrated Circuitry (ASIC), programmable logic arrays, and/or using one or more Digital Signal Processors (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, a 5G New Radio (NR) Radio Access Network (RAN) or a 6G RAN) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), a 6G Core (6GC), or the internet), through an RAN established by one or more BSs.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), 6G and/or LTE-A Pro. However, the scope of the present disclosure should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides service to one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapping coverage areas with other cells.

As discussed above, the frame structure for NR is to support flexible configurations for accommodating various next-generation (e.g., 5G or 6G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, or B exists alone. In addition, the character “/” herein generally represents that the former and latter associated objects are in an “or” relationship.

The following description contains specific information pertaining to exemplary embodiments in the present disclosure. The drawings in the present disclosure and their accompanying detailed description are directed to merely exemplary embodiments. However, the present disclosure is not limited to merely these exemplary embodiments. Other variations and embodiments of the present disclosure will occur to those skilled in the art. Unless noted otherwise, like or corresponding elements among the figures may be indicated by like or corresponding reference numerals. Moreover, the drawings and illustration in the present disclosure are generally not to scale, and are not intended to correspond to actual related dimensions.

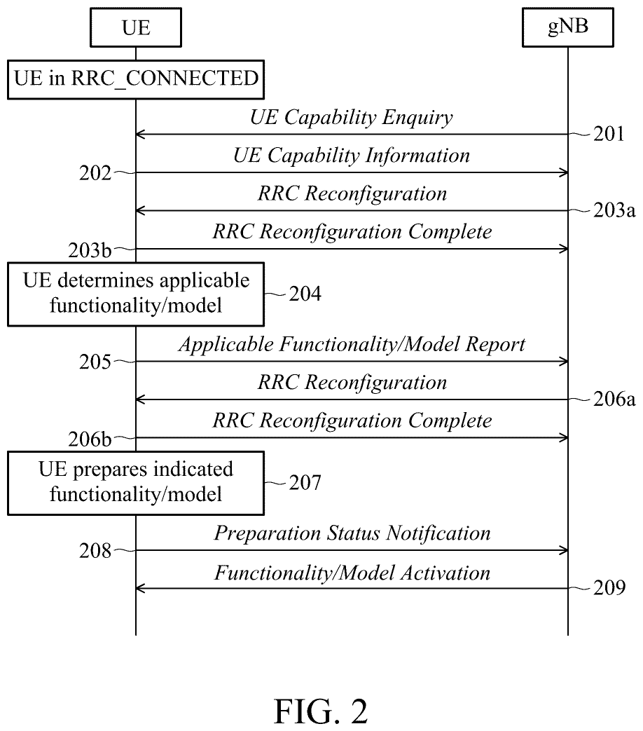

FIG. 2 shows a signaling procedure for supporting AI/ML general framework for UE-side AI/ML model according to an implementation of the present disclosure. It should be noted that one or more steps in FIG. 2 may or may not be performed. For example, a UE may not transmit an Applicable Functionality/Model Report to the network (or the gNB) when the UE determines that there is no applicable functionality/model based on the UE's status and/or information provided by the network. For example, a gNB may not transmit a Functionality/Model Activation command to activate functionality/model A to the UE when the UE indicates that functionality/model A is not ready (or is not successfully built) in a received Preparation Status Notification message. For example, the information in an Applicable Functionality/Model Report in Step 205 may be transmitted in an RRC Reconfiguration Complete message in Step 203b. In this case, the Applicable Functionality/Model Report in Step 205 is not required in order to avoid transmitting duplicate information. Also, the order of the steps may not be mandatory. For example, the UE may start preparing an indicated functionality/model in Step 207 before transmitting a RRC Reconfiguration Complete message in Step 206b. It should be noted that functionality and model may be exchangeable in this disclosure. Also, the NW (Network) and the gNB may be exchangeable in this disclosure.

Step 201: In some implementations, a UE (e.g., a UE in the RRC_CONNECTED state) may receive a UE Capability Enquiry message (e.g., a UECapabilityEnquiry message as introduced in 3GPP Rel-18 TS 38.331) from a (serving) gNB. The UE Capability Enquiry message from the (serving) gNB may ask the UE to report AI/ML-related capabilities (e.g., AI/ML functionality/model(s) supported by the UE). In one implementation, a UE Capability Enquiry message may ask a UE to report AI/ML-related capabilities regarding beam management. In one implementation, a UE Capability Enquiry message may ask a UE to report AI/ML-related capabilities regarding positioning accuracy enhancements. In one implementation, a UE Capability Enquiry message may ask a UE to report AI/ML-related capabilities regarding CSI feedback enhancement.

Step 202: In some implementations, a UE may report its capability of supporting AI/ML mechanism(s) regarding air interface to NW via an RRC signaling (e.g., a UECapablityInformation message as introduced in 3GPP Rel-18 TS 38.331). When a UE supports AI/ML mechanism(s) regarding the air interface, the UE may support all or part of the (supported) functionality/model(s) related to beam management, positioning accuracy enhancements, and/or CSI feedback enhancement.

In some implementations, a UE may report its capability of supporting AI/ML mechanism(s) regarding beam management. When the UE supports AI/ML mechanism(s) regarding beam management, the UE may support both the UE-side model and the NW-side model for beam management. “Supporting a UE-side model” and “Supporting LCM operations for a UE-side model” may be interchangeable throughout this disclosure. “Supporting a NW-side model” and “Supporting LCM operations for a NW-side model” may be interchangeable throughout this disclosure. LCM operations include model training, model deployment, model inference, model monitoring and/or model updating, but not limited to.

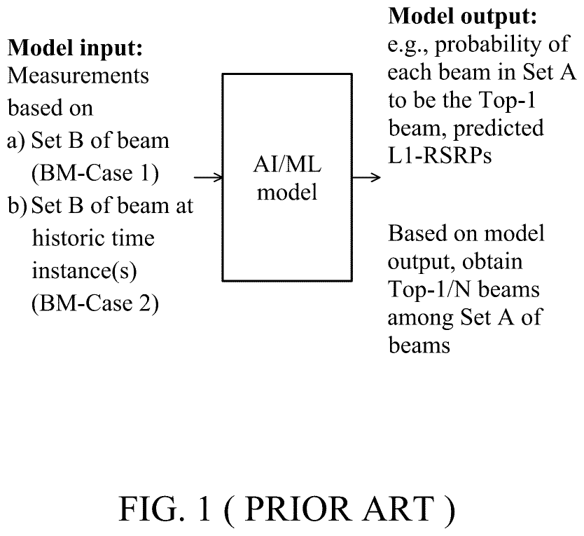

In one implementation, a UE may report separate capabilities of supporting AI/ML mechanism(s) regarding beam management, one for supporting the UE-side model for beam management and the other for supporting the NW-side model for beam management. In one implementation, a UE may report separate capabilities of supporting a UE-side model for beam management, one for spatial-domain DL Tx beam prediction, and the other for temporal DL Tx beam prediction. It should be noted that spatial-domain DL Tx beam prediction is to predict the signal quality of beam(s) in Set A based on measurement results of Set B of beams as shown in FIG. 1. Temporal DL Tx beam prediction is to predict signal quality of beam(s) in Set A at different time point(s) in the future based on the historic measurement results of Set B of beams as shown in FIG. 1. In one implementation, a UE may report separate capabilities of supporting NW-side model for beam management, one for spatial-domain DL Tx beam prediction and the other for temporal DL Tx beam prediction.

In one implementation, a UE may report separate capabilities of supporting AI/ML mechanism(s) regarding positioning accuracy enhancements, one for supporting a UE-side model for positioning accuracy enhancements and the other for supporting a NW-side model for positioning accuracy enhancements. It should be noted that the NW-side model here may be an LMF (Location Management Function)-based model.

In some embodiments, the capabilities may be separated for FR1 (Frequency Range 1) and FR2 (Frequency Range 2). For example, a UE may report one capability of supporting AI/ML mechanism(s) regarding beam management in FR1 and may report another capability of supporting AI/ML mechanism(s) regarding beam management in FR2. In another example, a UE may report one capability of supporting a UE-side model for beam management in FR1 and may report another capability of a UE-side model for beam management in FR2. In another example, a UE may report one capability of supporting the NW-side model for beam management in FR1 and may report another capability of the NW-side model for beam management in FR2.

Step 203a: In some implementations, a (serving) gNB may transmit an RRC Reconfiguration message including an otherConfig (as introduced in 3GPP Rel-18 TS 38.331) which indicates that a UE is allowed to transmit an (current) Applicable Functionality/Model(s) Report via an RRC signaling (e.g., a UE Assistance Information message or an RRC Reconfiguration Complete message) or an MAC (Media Access Control) CE (Control Element). In some implementations, when an RRC Reconfiguration message includes the otherConfig, the received otherConfig includes the configuration of applicable functionality/model reporting, and the configuration of applicable functionality/model reporting is set to setup (or is enabled), a UE that receives the RRC Reconfiguration message may consider itself to be configured to send an Applicable Functionality/Model Report. In some implementations, when an RRC Reconfiguration message includes the otherConfig, the received otherConfig includes the configuration of applicable functionality/model reporting and the configuration of applicable functionality/model reporting is set to release (or is not set to setup, or is disabled), a UE that receives the RRC Reconfiguration message may not consider itself to be configured to send an Applicable Functionality/Model Report. In addition, any timer associated with the applicable functionality/model reporting may be stopped accordingly (e.g., a timer T1).

In some implementations, a (serving) gNB may transmit a RRC Reconfiguration message including an otherConfig (as introduced in 3GPP Rel-18 TS 38.331) which indicates that a UE is allowed to transmit an (current) Applicable Functionality/Model(s) Report, information related to a NW-side additional condition (for a UE-side model), inference configuration(s)/parameter(s) (or prediction report configuration(s)) of one or more functionality/models (for a UE-side model), training data report configuration(s)/parameter(s) of one or more functionality/models (for a NW-side model), training-related configurations/parameters of one or more functionality/models, performance monitoring related configuration(s)/parameter(s) of one or more functionality/models, the identity of one or more functionality/models (or intended/indicated functionality/models), Set A (resource) related information of one or more functionality/models and/or Set B (resource) related information of one or more functionality/models, based on UE capabilities/NW preferences. It should be noted that information related to the NW-side additional condition may be an associated ID, which can be used to ensure the consistency of the NW-side additional condition across training and inference for the UE-sided model. A UE may assume the similar properties of a DL Tx beam or beam set/list associated with the same associated ID. In some implementations, a (serving) gNB may transmit an RRC Reconfiguration message including only necessary information for a UE to determine an (current) applicable functionality/model(s) in Step 203a. Other information may be provided in another RRC Reconfiguration message in Step 206a (e.g., based on the UE's feedback in Step 205).

In some implementations, a (serving) gNB may transmit an RRC Reconfiguration message including an otherConfig (as introduced in 3GPP Rel-18 TS 38.331) which indicates that a UE is allowed to transmit an (current) Applicable Functionality/Model(s) Report and a report indication to indicate the UE to report (current) Applicable Functionality/Model(s) in a corresponding RRC Reconfiguration Complete message. Accordingly, the UE may be allowed to report an Applicable Functionality/Model Report in the corresponding RRC Reconfiguration Complete message when the Applicable Functionality/Model Report is available.

In some implementations, a (serving) gNB may transmit an RRC Reconfiguration message including an otherConfig (as introduced in 3GPP Rel-18 TS 38.331) which indicates that a UE is allowed to transmit an (current) Applicable Functionality/Model(s) Report and a report indication to indicate the UE is allowed to report (current) Applicable Functionality/Model(s) in a corresponding RRC Reconfiguration Complete message. Accordingly, the UE may be allowed to report an Applicable Functionality/Model Report in the corresponding RRC Reconfiguration Complete message when the Applicable Functionality/Model Report is available.

Step 203b: In some implementations, a UE may respond an RRC Reconfiguration Complete message when the UE receives an RRC Reconfiguration message including an otherConfig (as introduced in 3GPP Rel-18 TS 38.331) which indicates that the UE is allowed to transmit an (current) Applicable Functionality/Model(s) Report via an RRC signaling (e.g., a UE Assistance Information message or an RRC Reconfiguration Complete message) or an MAC CE. In some implementations, when a UE receives an RRC Reconfiguration message including an otherConfig which indicates that the UE is allowed to transmit the (current) Applicable Functionality/Model(s) Report and the UE may determine (current) applicable functionality/model(s) by following the processing delay requirements for RRC Reconfiguration procedure (e.g., 10 ms), the UE may include the information of the (current) Applicable Functionality/Model(s) in the corresponding RRC Reconfiguration Complete message in Step 203b. The information of a (current) Applicable Functionality/Model or its associated inference configuration/parameter(s) may be applicable or inapplicable. For example, when a UE receives an RRC Reconfiguration message including an otherConfig which indicates that the UE is allowed to transmit the (current) Applicable Functionality/Model(s) Report, the UE may perform an applicability determination procedure to determine whether a UE-side functionality/model or its associated inference configuration/parameter(s) is applicable. When the UE-side functionality/model or its associated inference configuration/parameter(s) is determined to be ready for inference by the end of a pre-specified RRC processing delay, the UE may report the UE-side functionality/model or its associated inference configuration/parameter(s) to be applicable. When the UE-side functionality/model or its associated inference configuration/parameter(s) is not determined to be ready for inference by the end of a pre-specified RRC processing delay, the UE may report the UE-side functionality/model or its associated inference configuration/parameter(s) to be inapplicable. In some implementations, when a UE receives an RRC Reconfiguration message including an otherConfig which indicates that the UE is allowed to transmit an (current) Applicable Functionality/Model(s) Report and a report indication to indicate the UE to (or is allowed to) report (current) Applicable Functionality/Model(s) in a corresponding RRC Reconfiguration Complete message, and the UE may determine (current) applicable functionality/model(s) and/or (current) applicable functionality/model set(s) by following the processing delay requirements for RRC Reconfiguration procedure (e.g., 10 ms), the UE may include the information of the (current) Applicable Functionality/Model(s) and/or (current) applicable functionality/model set(s) in the corresponding RRC Reconfiguration Complete message in Step 203b. In a case that the UE may not meet the processing delay requirements for the RRC Reconfiguration procedure (e.g., 10 ms), the UE may not include the Applicable Functionality/Model Report in the RRC Reconfiguration Complete message.

Step 204: In some implementations, a UE may determine (current) applicable functionality/model(s) and/or applicable functionality/model set(s) based on information (e.g., information related to a NW-side additional condition (for a UE-side model), inference configuration(s)/parameter(s) (or prediction report configuration(s)) of one or more functionality/models (for a UE-side model)) received in Step 203a. In some implementations, based on UE's current status (e.g., memory storage, calculation/CPU loading, or power state and/or the additional NW condition(s)), a UE may determine one or more (current) applicable functionality/model(s) and/or one or more (current) applicable functionality/model sets (e.g., by performing an applicability determination procedure).

Step 205: In some implementations, after determining one or more (current) applicable functionality/models and/or one or more (current) applicable functionality/model sets, the UE may report the one or more (current) applicable functionality/models and/or one or more (current) applicable functionality/model sets in a the (current) Applicable Functionality/Model(s) Report via an RRC signaling in Step 205. In one implementation, a UE may report that functionality/model A and/or the associated training/reporting/inference configuration(s)/parameter(s) is (currently) applicable. In one implementation, a UE may report that functionality/model B is (currently) not applicable and/or the reason for inapplicability (e.g., due to memory limit or power shortage). In one implementation, a UE may report that functionality/model set {A, C} and/or the associated/preferred training/reporting/inference configuration(s)/parameter(s) is (currently) applicable. It should be noted that in the functionality/model set {A, C}, A may be a UE-side model or NW-side model. Similarly, C may be a UE-side model or NW-side model. When the UE reports that functionality/model set {A, C} is (currently) applicable, it means that the UE can perform LCM operations for functionality/model A and functionality/model C simultaneously.

In one implementation, a UE may report that functionality/model A is (currently) applicable and/or the functionality/model A is trained/ready (i.e., training phase is not required). In one implementation, a UE may report that functionality/model A is (currently) applicable and/or that the functionality/model A is untrained (i.e., training phase is required).

In some implementations, a UE may start determining (current) applicable functionality/model(s) and/or (current) applicable functionality/model set(s) upon receiving an RRC Reconfiguration message in Step 203. In a case that the UE is able to report the determined (current) applicable functionality/model(s) and/or the determined (current) applicable functionality/model set(s) in Step 203b, the UE may not transmit an Applicable Functionality/Model Report with the same information in Step 205. In some implementations, when a UE does not transmit an Applicable Functionality/Model Report via an RRC signaling (e.g., a UE Assistance Information message or an RRC Reconfiguration Complete message) since the UE is configured to provide Applicable Functionality/Model Report, or when the (current) Applicable Functionality/Model Report is different from the one indicated in the last transmission of an RRC signaling (e.g., a UE Assistance Information message or an RRC Reconfiguration Complete message) including Applicable Functionality/Model Report, the UE may initiate transmission of the Applicable Functionality/Model Report via an RRC signaling (e.g., a UE Assistance Information message or an RRC Reconfiguration Complete message). An Applicable Functionality/Model Report may include the information to indicate which Functionality/Model(s) are applicable and/or which are inapplicable.

In some implementations, a time T1 may start (or restart) upon transmitting an Applicable Functionality/Model Report via an RRC signaling (e.g., a UE Assistance Information message or an RRC Reconfiguration Complete message) or an MAC CE. The UE may be allowed to transmit another Applicable Functionality/Model Report when the timer T1 is not running (or expires). Upon releasing the configuration of applicable functionality/model reporting during the connection reestablishment/resume procedures, and/or upon receiving the configuration of applicable functionality/model reporting set to release, the timer T1 may stop. The value of timer T1 may be configurable or pre-defined. In one implementation, when the value of timer T1 is not configured, a UE that is allowed to transmit an Applicable Functionality/Model Report may be allowed to transmit an Applicable Functionality/Model Report at any time.

In some implementations, when a UE does not transmit an Applicable Functionality/Model Report via an RRC signaling (e.g., a UE Assistance Information message or an RRC Reconfiguration Complete message) since the UE is configured to provide Applicable Functionality/Model Report, or when the (current) Applicable Functionality/Model Report is different from the one indicated in the last transmission of RRC signaling (e.g., a UE Assistance Information message or an RRC Reconfiguration Complete message) including Applicable Functionality/Model Report and timer T1 is not running, the UE may initiate transmission of the Applicable Functionality/Model Report via an RRC signaling (e.g., a UE Assistance Information message or an RRC Reconfiguration Complete message).

Step 206a: In some implementations, a (serving) gNB may transmit an RRC Reconfiguration message including necessary information or configuration(s)/parameter(s) for one or more applicable functionality/models based on the latest received Applicable Functionality/Model Report from a UE and/or identification information of one or more applicable functionality/models to be indicated/selected. For an applicable model, part of the related configuration(s)/parameter(s) may be received from the RRC Reconfiguration message in Step 203a, and the rest of the related configuration(s)/parameter(s) may be received from the RRC Reconfiguration message in Step 206a. For example, for a UE-side model A, a UE may receive the corresponding training-related configuration(s)/parameter(s), Set A (resource) related information, and/or Set B (resource) related information in the RRC Reconfiguration message in Step 203a. In addition, the UE may receive the corresponding inference configuration(s)/parameter(s) (or prediction report configuration(s)) in the RRC Reconfiguration message in Step 206a. In some implementations, a (serving) gNB may transmit an RRC Reconfiguration message including performance monitoring related configuration(s)/parameter(s) of an applicable functionality/mode in Step 206a.

Step 207: In some implementations, before a UE starts preparing an indicated UE-side functionality/model (i.e., build the UE-side model), the UE may request training data collection via an RRC signaling (e.g., a Reconfiguration Complete message or a New RRC message), an MAC CE, or a DCI (Downlink Control Information) for one or more models. In some implementations, a UE may be allowed to request training data collection for a UE-side model when receiving an indication from the NW via dedicated signaling (e.g., an RRC Reconfiguration message) or broadcasting system information. In one implementation, upon receiving the response from the NW in response to the request, the UE may immediately start collecting data for the interested CSI-RS/SSB set A/B based on the corresponding CSI-RS/SSB resource(s) to build a UE-side functionality/model. In another implementation, upon receiving the response from the NW in response to the request, the UE starts data collection to build a UE-side functionality/model after time T2. For example, when the UE receives the response at time N, the UE starts collecting data at time N+T2. The value of T2 may be configurable or pre-defined. The unit of time T2 may be a slot, sub-frame, frame, or ms (millisecond). In some implementations, upon a UE transmitting a request for training data collection, a timer T4 starts (or restarts). When the timer T4 expires, the UE may be allowed to transmit another request for training data collection.

In some implementations, when a UE receives an indication from the NW via dedicated signaling (e.g., an RRC Reconfiguration message) or broadcasting system information associated with a UE-side model, the UE starts preparing an indicated UE-side functionality/model and tries to build the indicated UE-side functionality/model. That is, the NW may instruct the UE to collect data for the interested CSI-RS/SSB Set A/B for training an applicable functionality/model. The NW may first provide the related resource(s) for CSI-RS/SSB set A/B (e.g., in a RRC Reconfiguration message), and then may transmit another command (e.g., an RRC signal, an MAC CE, or DCI) to instruct the UE to start collecting data for the interested CSI-RS/SSB set A/B based on the corresponding CSI-RS/SSB resource(s) to build a UE-side functionality/model. In one implementation, when a UE receives the command to instruct the UE to collect data for the interested CSI-RS/SSB set A/B based on the corresponding CSI-RS/SSB resource(s) to build a UE-side functionality/model, the UE may immediately start collecting data. In another implementation, when a UE receives the command to instruct the UE to collect data for interested CSI-RS/SSB set A/B based on the corresponding CSI-RS/SSB resource(s), the UE starts data collection to build a UE-side functionality/model after time T3. For example, when the UE receives the command at time N, the UE starts collecting data at time N+T3. The value of T3 may be configurable or pre-defined. The unit of time T3 may be a slot, sub-frame, frame, or ms.

In some implementations, when Set A (resource) related information and/or Set B (resource) related information is released/invalid/unavailable, the UE may stop preparing an associated indicated UE-side functionality/model.

In some implementations, when a UE receives an indication from the NW via dedicated signaling (e.g., an RRC Reconfiguration message in Step 203a or Step 206a) with associated information (e.g., training-related configuration(s)/parameter(s), Set A (resource) related information, and/or Set B (resource) related information) for a UE-side model, the UE may start collecting data immediately to build the UE-side model. In another implementation, when a UE receives an indication from the NW via dedicated signaling (e.g., an RRC Reconfiguration message in Step 203a or Step 206a) with associated information (e.g., training-related configuration(s)/parameter(s), Set A (resource) related information and/or Set B (resource) related information) for a UE-side model, the UE may start collecting data immediately to build the UE-side model after time T5. For example, when the UE receives the RRC Reconfiguration message at time N, the UE may start collecting data at time N+T5. The value of T5 may be configurable or pre-defined. The unit of time T5 may be a slot, sub-frame, frame, or ms.

Step 208: In some implementations, a UE may report to the NW that an indicated UE-side functionality/model is successfully built, via an RRC signaling (e.g., a Preparation Status Notification message or a new RRC message), an MAC CE, or a DCI. In some implementations, a UE may report to the NW that an indicated UE-side functionality/model is not successfully built and/or the reason (e.g., insufficient training data or low prediction accuracy), via an RRC signaling (e.g., a Preparation Status Notification message or a new RRC message), an MAC CE, or a DCI. In one implementation, in a case that the NW is informed that one UE-side functionality/model is not successfully built, the NW may request the UE to report the latest applicable functionality/model(s). In one implementation, in a case that the UE determines that one UE-side functionality/model is not successfully built, the UE may suspend/release the corresponding configuration(s)/parameter(s) of the UE-side functionality/model and/or suspend/stop the corresponding LCM operation(s) associated with the UE-side functionality/model.

Step 209: In some implementations, when an applicable functionality/model is ready (or is successfully built) (e.g., based on the information provided in an Applicable Functionality/Model Report or the information provided in a Preparation Status Notification message), the NW may transmit a Functionality/Model Activation Command (e.g., an RRC signaling, an MAC CE or a DCI) to activate the applicable functionality/model. When the applicable functionality/model is activated, the UE may perform the inference operation and report the prediction results based on the associated inference configuration(s)/parameter(s) (or prediction report configuration(s)). An inference configuration may be a CSI-ReportConfig. For a UE-side model, periodic CSI report, aperiodic CSI report, and semi-persistent CSI report may be supported for inference report, at least for beam management.

In some implementations, when an associated inference configuration(s)/parameter(s) of an applicable functionality/model is for aperiodic CSI report, the applicable functionality/model is considered as an activated functionality/model upon receiving a DCI, which is used to trigger aperiodic CSI report (e.g. of a UE-side model). It should be noted that when a aperiodic CSI report is triggered, the UE may transmit an aperiodic CSI report on corresponding (configured) resource(s) and the aperiodic CSI repot may include predicted signal quality (e.g., RSRP value, RSRQ value, or SINR value, but not limited to) of one or more beams, wherein the one or more beams are indicated by NW. When a lower layer (e.g., the PHY layer) of the UE receives the DCI, which is used to trigger aperiodic CSI report, the lower layer of the UE may inform an upper layer of the UE (e.g., the RRC layer) that the corresponding functionality/model is activated. The upper layer of the UE may use the information to determine whether the (current) activated functionality/model(s) exceed the UE's overall capabilities (e.g., memory storage, calculation/CPU loading, or power). When the (current) activated functionality/model(s) exceed the UE's overall capabilities, the UE may transmit an Applicable Functionality/Model Report (e.g., indicating that an applicable functionality/model has become inapplicable) to the NW for further instruction. In some implementations, when a UE determines that an activated model (e.g., a UE-side model) is not applicable, the UE may stop associated LCM operations of the activated model and may suspend/stop the corresponding configuration(s)/parameter(s) to wait for the NW's further instruction(s)/configuration(s). In some implementations, the upper layer may perform the performance monitoring related configuration(s)/parameter(s) of the activated functionality/model when configured (or instructed to perform). The upper layer of the UE (or the UE) may report the results of the performance monitoring based on the performance monitoring related configuration(s)/parameter(s). In one implementation, the UE may automatically suspend/stop the LCM operations of the activated functionality/model and/or apply a default configuration(s)/parameter(s) to perform legacy CSI-RS/SSB measurements when its performance is worse than or equal to a pre-configured condition. In some implementations, when the aperiodic CSI report is completed, the lower layer of the UE may inform an upper layer of the UE (e.g., the RRC layer) that the corresponding functionality/model is deactivated. In some implementations, a DCI may be used to trigger aperiodic CSI reports of one or more functionality/models. In some implementations, a field of the DCI may be used to indicate which functionality/model is to be triggered for an aperiodic CSI report. In some implementations, a field of the DCI may be used to indicate which functionality/model is to be triggered for an aperiodic CSI report, wherein the first bit in the field indicates the first functionality/model which is configured for aperiodic CSI report, and the second bit in the field indicates the second functionality/model which is configured for aperiodic CSI report. The number of bits for this field may be fixed, configured, or based on the number of functionality/model(s) configured for aperiodic CSI report.

In some implementations, when an associated inference configuration(s)/parameter(s) of an applicable functionality/model is for a semi-persistent CSI report (e.g., a semi-persistent CSI report using PUCCH/Physical Uplink Control Channel or semi-persistent CSI report using PUSCH/Physical Uplink Shared Channel), the applicable functionality/model is considered as an activated functionality/model upon receiving an MAC CE, which is used to activate the semi-persistent CSI report (e.g., of a UE-side model). It should be noted that when a semi-persistent CSI report is activated, the UE may transmit one or more semi-persistent CSI reports on corresponding (configured) resource(s) and the one or more semi-persistent CSI reports may include predicted signal quality (e.g., RSRP value) of one or more beams, wherein the one or more beams are indicated by the NW. When a lower layer (e.g., the MAC layer) of the UE receives the MAC CE, which is used to trigger a semi-persistent CSI report, the lower layer of the UE may inform an upper layer of the UE (e.g., the RRC layer) that the corresponding functionality/model is activated. The upper layer of the UE may use the information to determine whether the (current) activated functionality/model(s) exceed the UE's overall capabilities (e.g., memory storage, calculation/CPU loading, or power). When the (current) activated functionality/model(s) exceed the UE's overall capabilities, the UE may transmit an Applicable Functionality/Model Report (e.g., indicating that an applicable functionality/model has become inapplicable) to the NW for further instruction. In some implementations, when a UE determines that an activated model (e.g., a UE-side model) is not applicable, the UE may stop associated LCM operations of the activated model and may suspend/stop the corresponding configuration(s)/parameter(s) to wait for the NW's further instruction(s)/configuration(s). In some implementations, the upper layer may perform the performance monitoring related configuration(s)/parameter(s) of the activated functionality/model when configured (or instructed to perform). The upper layer of the UE (or the UE) may report the results of the performance monitoring based on the performance monitoring related configuration(s)/parameter(s). In one implementation, the UE may automatically suspend/stop the LCM operations of the activated functionality/model and/or apply a default configuration(s)/parameter(s) to perform legacy CSI-RS/SSB measurements when its performance is worse than or equal to a pre-configured condition. In some implementations, when receiving an MAC CE that is used to deactivate aperiodic CSI report, the lower layer of the UE may inform an upper layer of the UE (e.g., the RRC layer) that the corresponding functionality/model is deactivated. In some implementations, an MAC CE may be used to activate semi-persistent CSI report of one or more functionality/models. In some implementations, a field of the MAC CE may be used to indicate which functionality/model is to be activated for a semi-persistent CSI report. In some implementations, a field of the MAC CE may be used to indicate which functionality/model is to be activated for an semi-persistent CSI report, wherein the first bit in the field indicates the first functionality/model which is configured for semi-persistent CSI report, and the second bit in the field indicates the second functionality/model which is configured for semi-persistent CSI report. The number of bits for this field may be fixed, configured, or based on the number of functionality/model(s) configured for semi-persistent CSI report.

In some implementations, when an associated inference configuration(s)/parameter(s) of an applicable functionality/model is for periodic CSI report and the associated inference configuration(s)/parameter(s) is activated by an RRC signaling (e.g., an RRC Reconfiguration including the associated CSI-ReportConfig for inference in the ToAddMod list), the applicable functionality/model is considered as an activated functionality/model. It should be noted that when a periodic CSI report is activated, the UE may transmit one or more periodic CSI reports on corresponding (configured) resource(s) and the one or more periodic CSI reports may include predicted signal quality (e.g., an RSRP value) of one or more beams, wherein the one or more beams are indicated by the NW. The UE may determine whether the (current) activated functionality/model(s) exceed the UE's overall capabilities (e.g., memory storage, calculation/CPU loading, or power). When the (current) activated functionality/model(s) exceed the UE's overall capabilities, the UE may transmit an Applicable Functionality/Model Report (e.g., indicating that an applicable functionality/model has become inapplicable) to the NW for further instruction. In some implementations, when a UE determines that an activated model (e.g., a UE-side model) is not applicable, the UE may stop associated LCM operations of the activated model and may suspend/stop the corresponding configuration(s)/parameter(s) to wait for the NW's further instruction(s)/configuration(s). In some implementations, the upper layer may perform the performance monitoring related configuration(s)/parameter(s) of the activated functionality/model when configured (or instructed to perform). The UE may report the results of the performance monitoring based on the performance monitoring related configuration(s)/parameter(s). In one implementation, the UE may automatically suspend/stop the LCM operations of the activated functionality/model and/or apply a default configuration(s)/parameter(s) to perform legacy CSI-RS/SSB measurements when its performance is worse than or equal to a pre-configured condition. In some implementations, if an associated inference configuration(s)/parameter(s) of an applicable functionality/model is for periodic CSI report and the associated inference configuration(s)/parameter(s) is deactivated by an RRC signaling (e.g., an RRC Reconfiguration including the associated CSI-ReportConfig for inference in the ToRelease list), the applicable functionality/model is considered as an activated functionality/model.

In some implementations, when an applicable UE-side model of a UE is ready (or is successfully built) and the UE transits from the RRC_CONNECTED state to the RRC_IDLE state or the RRC_INACTIVE state, the UE may release the applicable UE-side model and/or the associated configuration(s)/parameter(s) (e.g., for data collection or for performance monitoring).

In some implementations, when an applicable UE-side model of a UE is ready (or is successfully built) and the UE transits from the RRC_CONNECTED state to the RRC_IDLE state or the RRC_INACTIVE state, the UE may keep the applicable UE-side model and/or the associated configuration(s)/parameter(s).

In some implementations, when an applicable UE-side model of a UE is ready (or is successfully built), the UE transits from the RRC_CONNECTED state to the RRC_IDLE state or the RRC_INACTIVE state, and the UE leaves the latest serving cell (or its associated base station) or a configured area (e.g., one or more tracking area, one or more RAN notification area, or an area configured by the NW), the UE may release the applicable UE-side model and/or the associated configuration(s)/parameter(s). A configured area may be a list of cell ID(s).

In some implementations, when an applicable UE-side model of a UE is ready (or is successfully built) and the UE transits from the RRC_CONNECTED state to the RRC_IDLE state or the RRC_INACTIVE state, the UE may follow the NW's command (e.g., an indication in an RRC Release message or an RRC Reconfiguration message) to keep or release the applicable UE-side model and/or the associated configuration(s)/parameter(s).

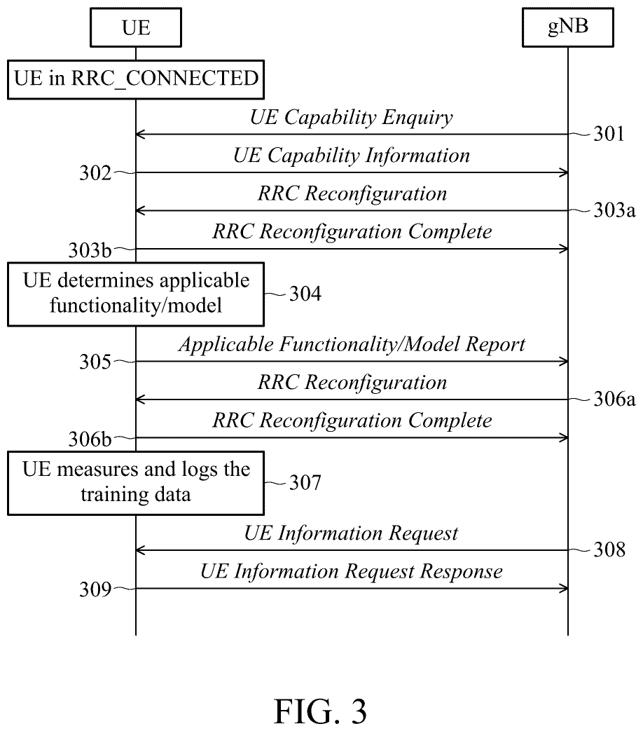

FIG. 3 shows a signaling procedure of supporting AI/ML general framework for NW-side AI/ML model according to an implementation of the present disclosure. It should be noted that one or more steps in FIG. 3 may or may not be performed. For example, a UE may not transmit an Applicable Functionality/Model Report to the network (or the gNB) when the UE determines there is no applicable functionality/model based on the UE's status and/or information provided by the network. For example, a gNB may not transmit a Functionality/Model Activation command to activate functionality/model A to the UE when the UE indicates that the functionality/model A is not ready (or is not successfully built) in a received Preparation Status Notification message. For example, the information in an Applicable Functionality/Model Report in Step 305 may be transmitted in an RRC Reconfiguration Complete message in Step 303b. In this case, the Applicable Functionality/Model Report in Step 305 is not required to avoid transmitting duplicate information. Also, the order of the steps may not be mandatory. It should be noted that functionality and model may be exchangeable in this disclosure. Also, the NW (Network) and the gNB may be exchangeable in this disclosure.

Step 301, Step 302, Step 303a, Step 303b, Step 304, and Step 305 of FIG. 3 may refer to Step 201, Step 202, Step 203a, Step 203b, Step 204, and Step 205 of FIG. 2.

Step 306a: In some implementations, a (serving) gNB may transmit an RRC Reconfiguration message including necessary information or configuration(s)/parameter(s) for one or more applicable functionality/models based on the (latest) received Applicable Functionality/Model Report from a UE and/or identification information of one or more applicable functionality/models to be indicated/selected. For an applicable model, part of the related configuration(s)/parameter(s) may be received from the RRC Reconfiguration message in Step 303a, and the rest of the related configuration(s)/parameter(s) may be received from the RRC Reconfiguration message in Step 306a. For example, for a NW-side model D, a UE may receive the corresponding training-related configuration(s)/parameter(s), Set A (resource) related information, and/or Set B (resource) related information in the RRC Reconfiguration message in Step 303a. The UE may perform measurements based on the received training-related configuration(s)/parameter(s) of a NW-side Model and may log the measurement results accordingly. In addition, the UE may receive the corresponding training data report configuration(s)/parameter(s) in the RRC Reconfiguration message in Step 306a. In some implementations, a (serving) gNB may transmit an RRC Reconfiguration message including performance monitoring related configuration(s)/parameter(s) of an applicable functionality/mode in Step 306a.

In some implementations, training-related configuration(s)/parameter(s) of a model may be provided for periodic logging. That is, the UE may measure and log the measurement results of Set A and/or Set B based on a configured period. The unit of a configured period may be a slot, sub-frame, frame, or ms. In addition, training-related configuration(s)/parameter(s) of a model may include a life timer. The life timer may start (or restart) when the UE starts measuring and logging the measurement results of Set A and/or Set B. The UE may stop measuring and logging the measurement results of Set A and/or Set B when the life timer expires. When the life timer is not configured or does not exist, the UE may keep measuring and logging the measurement results of Set A and/or Set B until the memory of the UE is full or the NW instructs the UE to stop measuring and logging the measurement results of Set A and/or Set B.

In some implementations, training-related configuration(s)/parameter(s) of a model may be provided for event-triggered periodic logging. That is, the UE may measure and log the measurement results of Set A and/or Set B based on a configured period when one or more triggered conditions are fulfilled. In some implementations, a trigger condition may be an RSRP (Reference Symbol Received Power), RSRQ (Reference Signal Received Quality), RSSI (Received Signal Strength Indication), or SINR (Signal-to-Interference-plus-Noise Ratio) threshold. In one implementation, when the currently measured downlink pathloss reference is less than or equal to the threshold, the UE may start or stop measuring and logging the measurement results of Set A and/or Set B. In one implementation, when the currently measured downlink pathloss reference is larger than or equal to the threshold, the UE may start or stop measuring and logging the measurement results of Set A and/or Set B. In some implementations, a trigger condition may be a location area (e.g., one or more tracking areas, one or more RAN notification areas, or an area configured by the NW). An area configured by the NW may be a list of cell ID(s). In one implementation, when the UE leaves the area, the UE may start or stop measuring and logging the measurement results of Set A and/or Set B. In one implementation, when the UE enters the area, the UE may start or stop measuring and logging the measurement results of Set A and/or Set B. It should be noted that one or more triggered conditions to be fulfilled for event-triggered periodic logging is configured by the NW. For example, the NW may configure a threshold and an area for event-triggered periodic logging at the same time. The UE may start measuring and logging the measurement results when all the triggered conditions are fulfilled. In a case that one of the triggered conditions is not fulfilled, the UE may stop measuring and logging the measurement results. In addition, training-related configuration(s)/parameter(s) of a model may include a life timer. The life timer may start when the UE starts measuring and logging the measurement results of Set A and/or Set B. The UE may stop measuring and logging the measurement results of Set A and/or Set B when the life timer expires. When the life timer is not configured or does not exist and the corresponding trigger condition(s) is fulfilled, the UE may keep measuring and logging the measurement results of Set A and/or Set B until the memory of the UE is full or the NW instructs the UE to stop measuring and logging the measurement results of Set A and/or Set B.

Step 306b: In some implementations, a UE may respond an RRC Reconfiguration Complete message when the UE receives an RRC Reconfiguration message. In some implementations, for a NW-side model, the UE may include information in the RRC Reconfiguration Complete message to request the NW for training data collection (e.g., to start transmitting beam(s) of Set A and Set B). In some implementations, a UE may include another Applicable Functionality/Model Report in the RRC Reconfiguration Complete message in Step 306b. In some implementations, for a NW-side model, the UE may include information (or an availability indicator) in the RRC Reconfiguration Complete message to inform the NW that the logged training data for a certain NW-side model is ready/available. The information may include an identification of a NW-side model, the size of the available training data, and/or the quality of the logged training data, but it should not be limited in the disclosure. The information may be transmitted via other RRC signaling (e.g., a UE Assistance Information message, an RRC Resume Request message, an RRC Connection Request message). The information may be transmitted via an MAC CE or a DCI. For example, a field of an MAC CE may indicate the identification of a NW-side model to indicate that the training data for the NW-side model is ready. For example, a field of a DCI may indicate the identification of a NW-side model to indicate that the training data for the NW-side model is ready. In some implementations, a UE may measure and log training data for training a NW-side model in the RRC_CONNECTED state, the RRC_IDLE state, or the RRC_INACTIVE state. In some implementations, a UE may only measure and log training data for training a NW-side model in the RRC_CONNECTED state.

Step 307: In some implementations, based on received training-related configuration(s)/parameter(s) (e.g., for periodic logging or for event-triggered data logging), the UE may perform the measurements on the associated Set A and/or Set B and log the measurement results accordingly.

In some implementations, a UE may stop measuring and logging the measurement results of Set A and/or Set B when the memory of the UE is full or when the UE receives the NW's command to stop measuring and logging the measurement results of Set A and/or Set B. In case that Set A (resource) related information and/or Set B (resource) related information is released/invalid/unavailable, the UE may stop measuring and logging the measurement results of Set A and/or Set B.

In some implementations, when a UE has already started measuring and logging the measurement results of Set A and/or Set B for an applicable NW-side model (or already has some logged measurement results but does not report yet) and the UE transits from the RRC_CONNECTED state to the RRC_IDLE state or the RRC_INACTIVE state, the UE may keep the logged measurement results and/or may keep measuring and logging the measurement results of Set A and/or Set B for the applicable NW-side model.

In some implementations, when a UE has already started measuring and logging the measurement results of Set A and/or Set B for an applicable NW-side model (or already has some logged measurement results but does not report yet), the UE transits from the RRC_CONNECTED state to the RRC_IDLE state or the RRC_INACTIVE state, and/or the UE leaves the latest serving cell (or its associated base station) or a configured area (e.g., one or more tracking area, one or more RAN notification area, or an area configured by the NW), the UE may release the logged measurement results and/or may stop measuring and logging the measurement results of Set A and/or Set B for the applicable NW-side model. A configured area may be a list of cell ID(s).

In some implementations, when a UE has already started measuring and logging the measurement results of Set A and/or Set B for an applicable NW-side model (or already has some logged measurement results but does not report yet) and the UE transits from the RRC_CONNECTED state to the RRC_IDLE state or the RRC_INACTIVE state, the UE may follow the NW's command (e.g., an indication in an RRC Release message or an RRC Reconfiguration message) to keep or release the logged measurement results. The UE may follow the NW's command (e.g., an indication in an RRC Release message or an RRC Reconfiguration message) to keep or stop measuring and logging the measurement results of Set A and/or Set B for the applicable NW-side model.

In some implementations, the UE may perform the received training-related configuration(s)/parameter(s) (e.g., for Periodic logging or for Event-triggered data logging) when transiting from the RRC_CONNECTED state to the RRC_IDLE state or the RRC_INACTIVE state.

In some implementations, the UE may stop/suspend the received training-related configuration(s)/parameter(s) (e.g., for periodic logging or for event-triggered data logging) when transiting from the RRC_CONNECTED state to the RRC_IDLE state or the RRC_INACTIVE state. The UE may resume the received training-related configuration(s)/parameter(s) (e.g., for periodic logging or for event-triggered data logging) when transiting to the RRC_CONNECTED state again.

In some implementations, when a lower layer of the UE (e.g., the PHY layer) determines that measuring and logging the measurement results of Set A and/or Set B of a NW-side model is failed or not successfully, the lower layer of the UE may inform an upper layer of the UE (e.g., the RRC layer). The RRC layer of the UE may inform the NW that the training data collection of the NW-side model is failed. When the UE is not in the RRC_CONNECTED state, the UE may store the failure information and report it to the NW once transiting to the RRC_CONNECTED state.

In some implementations, when a lower layer of the UE measures Set A and/or Set B of a NW-side model, the lower layer of the UE may report the measurement results to an upper layer of the UE (e.g., the RRC layer). The upper layer of the UE may log the measurement results as the logged training data of the NW-side model and may report the logged training data when the NW asks for.

In some implementations, an upper layer of the UE (e.g., the RRC layer) may inform a lower layer of the UE (e.g., the PHY layer) that the memory/buffer is full. The lower layer of the UE may stop measuring Set A and/or Set B of one or more NW-side models.

In some implementations, a lower layer of the UE (e.g., the PHY layer) may inform an upper layer of the UE (e.g., the RRC layer) that the memory/buffer is full and/or the operation of measuring Set A and/or Set B of one or more NW-side models is stopped/suspended. The upper layer may transmit a notification message to modify the NW that training data collection is suspended/completed or the memory/buffer is full. Accordingly, the NW may request the UE to report the logged training data of one or more applicable NW-side models.

In some implementations, a UE may receive a NW command to start or stop collecting/logging training data for a NW-side model (e.g., via an RRC signaling, an MAC CE, or a DCI).

Step 308: In some implementations, a UE may receive a UE Information Request message which includes a request for logged training data. In some implementations, a UE may receive a UE Information Request message which includes a request for logged training data of one or more NW-side models. For example, the gNB may ask for the logged training data of NW-side model E and NW-side model F in the same UE Information Request message. In some implementations, a UE may receive a UE Information Request message which includes an indication to indicate the UE to continue data collection of a NW-side model after the corresponding logged training data has been transmitted in the corresponding UE Information Response message(s).

Step 309: In some implementations, when a UE receives a UE Information Request message which includes a request for logged training data and the UE has valid (stored) logged training data, the UE may transmit the logged training data to the NW via a UE Information Response message. In some implementations, when a UE receives a UE Information Request message which includes a request for logged training data of a NW-side model and the UE has valid (stored) logged training data for the NW-side model, the UE may transmit the logged training data of the NW-side model to the NW via a UE Information Response message. In some implementations, the UE may discard logged training data of a NW-side model upon successful delivery by the UE of the corresponding UE Information Response message. In some implementations, a UE may transmit logged training data of a NW-side model in one or more UE information Response messages.

In some implementations, the NW may use the received logged training data of a NW-side model to build the NW-side model for inference. In a case that more training data is required, the NW may command the UE to collect new training data for the NW-side model.

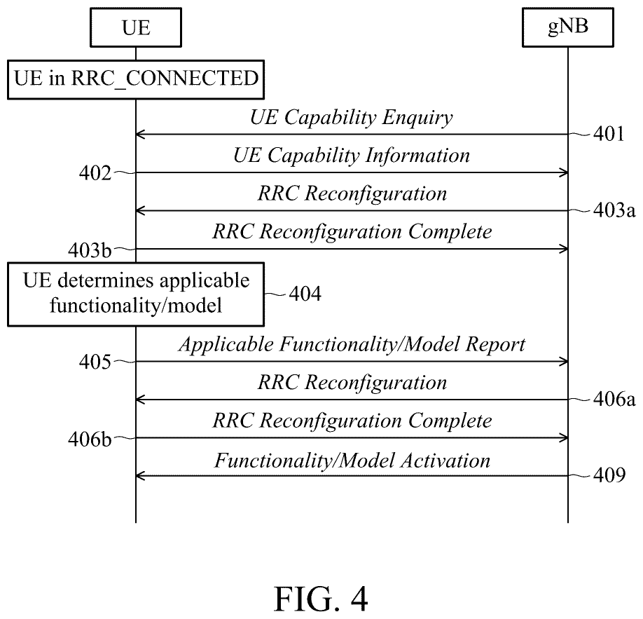

FIG. 4 shows an alternative signaling procedure of supporting AI/ML general framework for UE-side AI/ML model according to an implementation of the present disclosure. It should be noted that one or more steps in FIG. 4 may or may not be performed. Also, the order of the steps in FIG. 4 may not be mandatory.

Step 401, Step 402, Step 403a, Step 403b, Step 405, and Step 409 of FIG. 4 may refer to Step 201, Step 202, Step 203a, Step 203b, Step 205, and Step 209 of FIG. 2.

The difference between the signaling procedure in FIG. 4 and the signaling procedure in FIG. 2 is that applicable functionality/model(s) and/or applicable functionality/model set(s) determined by the UE in Step 404 is the applicable functionality/model(s) and/or applicable functionality/model set(s) that are ready (or are already trained) to perform the associated inference configuration(s)/parameter(s) (or prediction report configuration(s)), wherein the associated inference configuration(s)/parameter(s) (or prediction report configuration(s) may be received from a received RRC Reconfiguration message. In some implementations, a (serving) gNB may transmit an RRC Reconfiguration message including an otherConfig (as introduced in 3GPP Rel-18 TS 38.331) which indicates that a UE is allowed to transmit an (current) Applicable Functionality/Model(s) Report, information related to a NW-side additional condition (for UE-side model), inference configuration(s)/parameter(s) (or prediction report configuration(s)) of one or more functionality/models (for UE-side model), training data report configuration(s)/parameter(s) of one or more functionality/models (for NW-side model), training related configuration(s)/parameter(s) of one or more functionality/models, performance monitoring related configuration(s)/parameter(s) of one or more functionality/models, the identity of one or more functionality/models (or intended/indicated functionality/models), Set A (resource) related information of one or more functionality/models and/or Set B (resource) related information of one or more functionality/models, based on UE capabilities/NW preferences. The UE may determine whether an intended/indicated functionality/model(s) is applicable or not, based on the corresponding configuration(s)/parameter(s) and/or NW additional condition(s). The UE may determine an intended/indicated functionality/model(s) is applicable when the intended/indicated functionality/model(s) is successfully built (e.g., has already completed the training phase) and/or is ready to perform the corresponding inference configuration(s)/parameter(s) (or prediction report configuration(s)). That is, when the UE receives a command to active the intended/indicated functionality/model(s), the UE may start reporting the information (e.g., a CSI report including predicted signaling quality of one or more beams which are configured by the NW) to the NW based on the corresponding inference configuration(s)/parameter(s) (or prediction report configuration(s)). It should be noted that the predicted signaling quality may be a predicted RSRP value, RSRQ value, or SINR value, but it should not be limited to the disclosure. In Step 406a, the NW may indicate one or more selected functionality/models or sets to be activated and/or provide (updated/latest) inference configuration(s)/parameter(s) (or prediction report configuration(s)) for one or more selected functionality/models or sets. In Step 406b, the UE may respond whether one or more selected functionality/models or sets indicated in the RRC Reconfiguration message are still applicable. If not, the UE may indicate in the RRC Reconfiguration Complete message to indicate that one functionality/model or set is not applicable anymore.

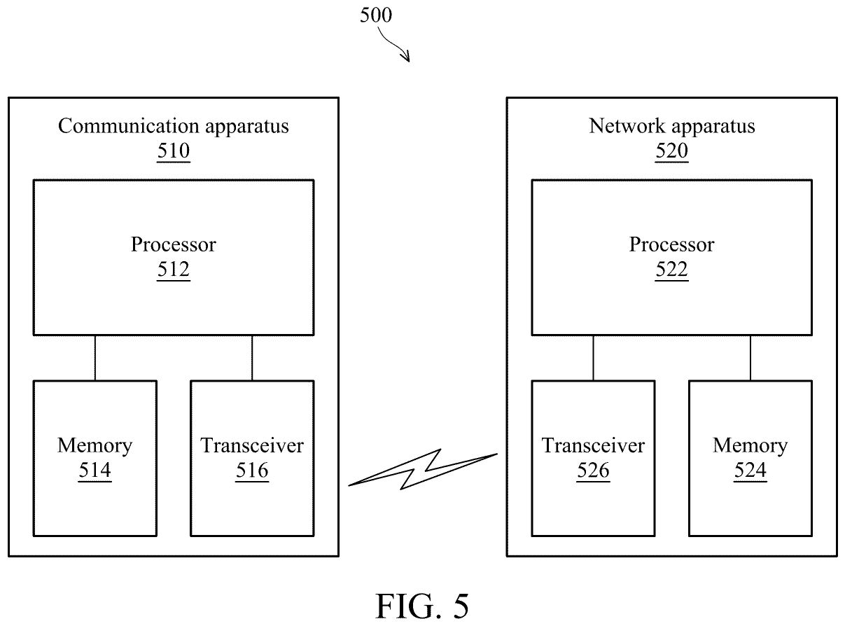

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to supporting artificial intelligence and machine learning functionality, including scenarios/schemes described above as well as process 500 described below.

The communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer, or a notebook computer. The communication apparatus 510 may also be a part of a machine-type apparatus, which may be an IoT, NB-IoT, or IIoT apparatus, such as an immobile or a stationary apparatus, a home apparatus, a wire communication apparatus, or a computing apparatus. For instance, the communication apparatus 510 may be implemented in a smart thermostat, a smart fridge, a smart door lock, a wireless speaker, or a home control center. Alternatively, the communication apparatus 510 may be implemented in the form of one or more integrated-circuit (IC) chips, such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5, such as a processor 512, for example. The communication apparatus 510 may further include one or more other components not pertinent to the proposed scheme of the present disclosure (e.g., internal power supply, display device and/or user interface device), and, thus, such component(s) of the communication apparatus 510 are neither shown in FIG. 5 nor described below in the interest of simplicity and brevity.

The network apparatus 520 may be a part of an electronic apparatus, which may be a network node such as a BS, a small cell, a router, or a gateway. For instance, the network apparatus 520 may be implemented in a gNB in a 5G, B5G, 6G, IoT, NB-IoT, or IIoT network. Alternatively, the network apparatus 520 may be implemented in the form of one or more IC chips, such as, for example, and without limitation, one or more single-core processors, one or more multi-core processors, or one or more RISC or CISC processors. The network apparatus 520 may include at least some of those components shown in FIG. 5, such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

In one aspect, each of the processor 512 and the processor 522 may be implemented in the form of one or more single-core processors, one or more multi-core processors, or one or more CISC processors. That is, even though a singular term “a processor” is used herein to refer to the processor 512 and the processor 522, each of the processor 512 and the processor 522 may include multiple processors in some implementations and a single processor in other implementations in accordance with the present disclosure. In another aspect, each of the processor 512 and the processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and the processor 522 is a special-purpose machine specifically designed, arranged and configured to perform specific tasks including a method for on-demand SIB1 requests in a UE (e.g., as represented by the communication apparatus 510) and a serving cell (e.g., as represented by the network apparatus 520) in accordance with various implementations of the present disclosure.

In some implementations, the communication apparatus 510 may also include a transceiver 516 coupled to the processor 512 and capable of wirelessly transmitting and receiving control and data signals. In some implementations, the transceiver 516 may be capable of wirelessly communicating with different types of BSs of different RATs. In some implementations, the transceiver 516 may be equipped with a plurality of antenna ports (not shown), such as, for example, four antenna ports. That is, the transceiver 516 may be equipped with multiple transmit antennas and multiple receive antennas for multiple-input multiple-output (MIMO) wireless communications. In some implementations, the network apparatus 520 may also include a transceiver 526 coupled to the processor 522 and capable of wirelessly transmitting and receiving control and data signals. In some implementations, the transceiver 526 may be capable of wirelessly communicating with different types of UEs of different RATs. In some implementations, the transceiver 526 may be equipped with a plurality of antenna ports (not shown), such as, for example, four antenna ports. That is, the transceiver 526 may be equipped with multiple transmit antennas and multiple receive antennas for MIMO wireless communications. Accordingly, the communication apparatus 510 and the network apparatus 520 may wirelessly communicate with each other via the transceiver 516 and the transceiver 526, respectively.

In some implementations, the communication apparatus 510 may further include a memory 514 coupled to the processor 512 and capable of being accessed by the processor 512 and storing data therein. In some implementations, the network apparatus 520 may further include a memory 524 coupled to the processor 522 and capable of being accessed by the processor 522 and storing data therein. Each of the memory 514 and the memory 524 may include a type of random-access memory (RAM) such as dynamic RAM (DRAM), static RAM (SRAM), thyristor RAM (T-RAM), and/or zero-capacitor RAM (Z-RAM). Alternatively, or additionally, each of the memory 514 and the memory 524 may include a type of read-only memory (ROM) such as mask ROM, programmable ROM (PROM), erasable programmable ROM (EPROM), and/or electrically erasable programmable ROM (EEPROM). Alternatively, or additionally, each of the memory 514 and the memory 524 may include a type of non-volatile random-access memory (NVRAM) such as flash memory, solid-state memory, ferroelectric RAM (FeRAM), magnetoresistive RAM (MRAM), and/or phase-change memory.

Each of the communication apparatus 510 and the network apparatus 520 may be a communication entity capable of communicating with each other using various proposed schemes in accordance with the present disclosure. For illustrative purposes and without limitation, a description of operations, functionalities, and capabilities of the communication apparatus 510, implemented in or as a UE (e.g., the UE in FIGS. 2 to 4), and the network apparatus 520, implemented in or as a base station (e.g., the gNB in FIGS. 2 to 4), is provided below.

According to certain proposed schemes of the present disclosure, the processor 512 of the communication apparatus 510 may receive, from the network apparatus 520, a Radio Resource Control (RRC) reconfiguration message including an inference configuration associated with a UE-side functionality. Then, the processor 512 may determine an applicability status of the inference configuration of the UE-side functionality. The processor 412 may transmit, to the base station, a first RRC reconfiguration complete message including the applicability status of the inference configuration of the UE-side functionality. In a case that a report configuration of applicability included in the RRC reconfiguration message is set to enabled, and a current applicability status of the inference configuration of the UE-side functionality is different from a previous applicability status reported in an RRC message, the processor 512 of the communication apparatus 510 may transmit the current applicability status of the configuration of the UE-side functionality in a second UE assistance information message to the network apparatus 520.

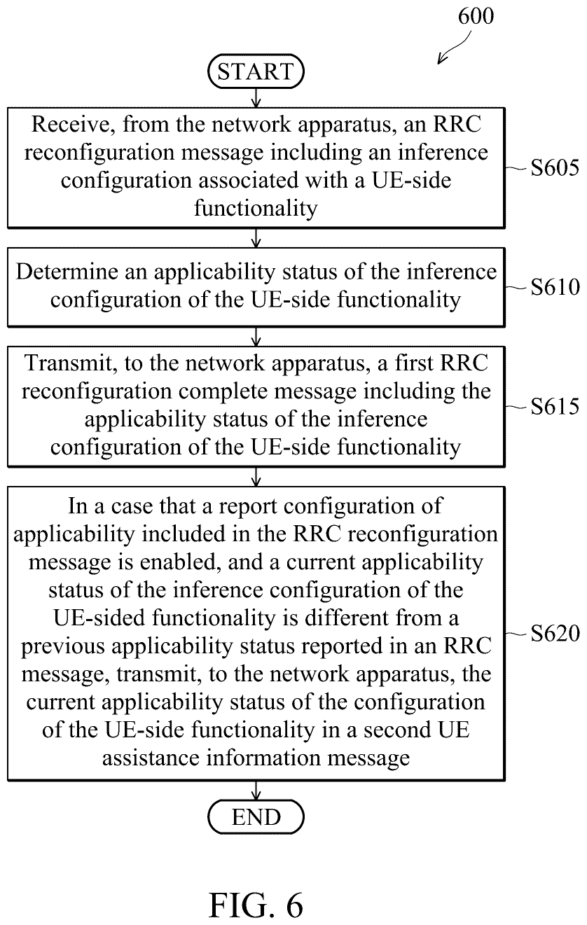

FIG. 6 illustrates an example process 600 in accordance with an implementation of the present disclosure. The process 600 may be an exemplary implementation of above scenarios/schemes, whether partially or completely, with respect to the method of supporting artificial intelligence and machine learning functionality. The process 600 may represent an aspect of the implementation of features of the communication apparatus 510. The process 600 may include one or more operations, actions, or functions as illustrated by one or more of block S605, S610, S615 and S620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 510 or any suitable UE. Solely for illustrative purposes and without limitation, the process 600 is described below in the context of the communication apparatus 510 as a UE and the network apparatus 520 as a base station or a gNB. The process 600 may begin at block S605.

In S605, the process 600 may involve the processor 512 of the communication apparatus 510 receiving, from the network apparatus 520, a Radio Resource Control (RRC) reconfiguration message including an inference configuration associated with a UE-side functionality. The process 600 may proceed from S605 to S610.

In S610, the process 600 may involve the processor 512 of the communication apparatus 510 determining an applicability status of the inference configuration of the UE-side functionality. The process 600 may proceed from S610 to S615.

In S615, the process 600 may involve the processor 512 of the communication apparatus 510 transmitting, to the network apparatus 520, a first RRC reconfiguration complete message including the applicability status of the inference configuration of the UE-side functionality. The process 600 may proceed from S615 to S620.

In S620, in a case that a report configuration of applicability included in the RRC reconfiguration message is enabled, and a current applicability status of the inference configuration of the UE-sided functionality is different from a previous applicability status reported in an RRC message, the process 600 may involve the processor 512 of the communication apparatus 510 transmitting, to the network apparatus 520, the current applicability status of the configuration of the UE-side functionality in a second UE assistance information message. In some implementations, the applicability status is either applicable or inapplicable.

In some implementations, the first RRC reconfiguration complete message including the applicability status has a processing latency requirement upon receiving the RRC reconfiguration message, and the applicability status is determined to be applicable or inapplicable by the end of a processing latency based on the processing latency requirement.

In some implementations, the RRC message is one of a second RRC reconfiguration complete message or a first UE assistance information message.

In some implementations, the process 600 may involve the processor 512 of the communication apparatus 510 sending, to the network apparatus 520, a training data collection request of the UE-side functionality.

In some implementations, the process 600 may involve the processor 512 of the communication apparatus 510 sending information of a preferred training data configuration for data collection associated with the UE-side functionality.

In some implementations, the process 600 may involve the processor 512 of the communication apparatus 510 receiving, from the network apparatus 520, a capability enquiry message for asking functionalities supported by the UE.

In some implementations, the process 600 may involve the processor 512 of the communication apparatus 510 receiving, from the network apparatus 520, a log data measurement configuration associated with a network-side functionality, performing a logging of measurement based on the log data measurement configuration, receiving, from the network apparatus 520, a logged data request indication in a UE information request message, transmitting, to the network apparatus 520, logged data in a UE information response message, and discarding the logged data upon the UE information response message is successfully delivered.

In some implementations, the process 600 may involve the processor 512 of the communication apparatus 510 discarding the logged data upon the UE transitions from an RRC Connected state to an RRC IDLE state or to an RRC INACTIVE state.

In some implementations, the process 600 may involve the processor 512 of the communication apparatus 510 stopping the logging of measurement when a memory of the UE is full or when the UE receives a command from the network apparatus 520 to stop the logging of measurement.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of supporting artificial intelligence and machine learning functionality, wherein the method is implemented by a user equipment (UE), and comprises:
receiving, from a base station, a Radio Resource Control (RRC) reconfiguration message including an inference configuration associated with a UE-side functionality;
determining an applicability status of the inference configuration of the UE-side functionality;
transmitting, to the base station, a first RRC reconfiguration complete message including the applicability status of the inference configuration of the UE-side functionality; and
in a case that a report configuration of applicability included in the RRC reconfiguration message is enabled, and a current applicability status of the inference configuration of the UE-side functionality is different from a previous applicability status reported in an RRC message, transmitting, to the base station, the current applicability status of the configuration of the UE-side functionality in a second UE assistance information message.

2. The method as claimed in claim 1, wherein the applicability status is either applicable or inapplicable.

3. The method as claimed in claim 1, wherein the first RRC reconfiguration complete message including the applicability status has a processing latency requirement upon receiving the RRC reconfiguration message, and the applicability status is determined to be applicable or inapplicable by the end of a processing latency based on the processing latency requirement.

4. The method as claimed in claim 1, wherein the RRC message is one of a second RRC reconfiguration complete message or a first UE assistance information message.

5. The method as claimed in claim 1, further comprising:
sending, to the base station, a training data collection request of the UE-side functionality.

6. The method as claimed in claim 1, further comprising:
sending information of a preferred training data configuration for data collection associated with the UE-side functionality.

7. The method as claimed in claim 1, further comprising:
receiving, from the base station, a capability enquiry message for asking functionalities supported by the UE.

8. The method as claimed in claim 1, further comprising:
receiving, from the base station, a log data measurement configuration associated with a network-side functionality;
performing a logging of measurement based on the log data measurement configuration;
receiving, from the base station, a logged data request indication in a UE information request message;
transmitting, to the base station, logged data in a UE information response message; and
discarding the logged data upon the UE information response message is successfully delivered.

9. The method as claimed in claim 8, further comprising:
discarding the logged data upon the UE transitions from an RRC Connected state to an RRC IDEL state or to an RRC INACTIVE state.

10. The method as claimed in claim 8, further comprising:
stopping the logging of measurement when a memory of the UE is full or when the UE receives a command from the base station to stop the logging of measurement.

11. An apparatus of supporting artificial intelligence and machine learning functionality, wherein the apparatus is a user equipment (UE) and comprises:
a transceiver which, during operation, wirelessly communicates with at least one network node; and
a processor communicatively coupled to the transceiver such that, during operation, the processor performs operations comprising:
receiving, from a base station, a Radio Resource Control (RRC) reconfiguration message including an inference configuration associated with a UE-side functionality;
determining an applicability status of the inference configuration of the UE-side functionality;
transmitting, to the base station, a first RRC reconfiguration complete message including the applicability status of the inference configuration of the UE-side functionality; and
in a case that a report configuration of applicability included in the RRC reconfiguration message is enabled, and a current applicability status of the configuration of the UE-side functionality is different from a previous applicability status reported in an RRC message, transmitting, to the base station, the current applicability status of the configuration of the UE-side functionality in a second UE assistance information message.

12. The apparatus as claimed in claim 11, wherein the applicability status is either applicable or inapplicable.

13. The apparatus as claimed in claim 11, wherein the first RRC reconfiguration complete message including the applicability status has a processing latency requirement upon receiving the RRC reconfiguration message, and the applicability status is determined to be applicable or inapplicable by the end of a processing latency based on the processing latency requirement.

14. The apparatus as claimed in claim 11, wherein the RRC message is one of a second RRC reconfiguration complete message or a first UE assistance information message.

15. The apparatus as claimed in claim 11, wherein the processor further performs operations comprising:
sending, to the base station, a training data collection request of the UE-side functionality.

16. The apparatus as claimed in claim 11, wherein the processor further performs operations comprising:
sending information of a preferred training data configuration for data collection associated with the UE-side functionality.

17. The apparatus as claimed in claim 11, wherein the processor further performs operations comprising:
receiving, from the base station, a capability enquiry message for asking functionalities supported by the UE.

18. The apparatus as claimed in claim 11, wherein the processor further performs operations comprising:
receiving, from the base station, a log data measurement configuration associated with a network-side functionality;
performing a logging of measurement based on the log data measurement configuration;
receiving, from the base station, a logged data request indication in a UE information request message;
transmitting, to the base station, logged data in a UE information response message; and
discarding the logged data upon the UE information response message is successfully delivered.

19. The apparatus as claimed in claim 18, wherein the processor further performs operations comprising:
discarding the logged data upon the UE transitions from an RRC Connected state to an RRC IDEL state or to an RRC INACTIVE state.

20. The apparatus as claimed in claim 18, wherein the processor further performs operations comprising:
stopping the logging of measurement when a memory of the UE is full or when the UE receives a command from the base station to stop the logging of measurement.
